(19) United States
(12) Patent Application Publication
(10) Pub. No.: US 2017/0291364 A1
(43) Pub. Date: Oct. 12, 2017

(54) SINGLE SCREW MICRO-EXTRUDER FOR 3D PRINTING

(71) Applicant: Timothy W. Womer, Edinburg, PA (US)

(72) Inventor: Timothy W. Womer, Edinburg, PA (US)

(21) Appl. No.: 15/456,871

(22) Filed: Mar. 13, 2017

Related U.S. Application Data
(60) Provisional application No. 62/320,768, filed on Apr. 11, 2016.
(60) Provisional application No. 62/364,356, filed on Jul. 20, 2016.

(51) Int. Cl. B29C 67/00; B29C 47/60; B29C 47/38; B33Y 30/00; B29C 47/12

(52) U.S. Cl. CPC B29C 67/0085; B33Y 30/00; B29C 47/12; B29C 47/385; B29C 47/60; B29K 2105/0067

(57) ABSTRACT

A single screw micro-extruder for a 3D printer includes a feed chamber with an opening for receiving solid plastic pellets. An extrusion barrel extends from the feed chamber and has an inner conically shaped bore between input and output ends. The bore has a mouth at the input end and an exit opening at the output end with a melt section therebetween. A rotatable screw is attached to a torque drive of the printer, and extends through the feed chamber and conical bore of the barrel. A constant or tapered diameter of the screw root core, from the input end toward the output end of the barrel, forms a decreasing channel root depth in a helical path for compression between a root core surface and an inner surface of the bore for pressurizing melt in the melt section of the barrel to exit an extrusion nozzle.

### PRIORITY DATA

This application claims priority to U.S. Provisional Patent Application Nos. 62/320,768, filed Apr. 11, 2016, and 62/364,356, filed Jul. 20, 2016, both of which are incorporated herein in their entirety.

### FIELD OF THE INVENTION

This invention relates to an extruder for 3D printing or other application from which a resin extrudes or flows for deposit. More particularly, this invention pertains to the arrangement, scaling, and structural form of a relatively small extruder having a screw rotating in a conical bore of an extrusion barrel for use with standard plastic pellets and/or micro-pellets, designed to be mounted is a vertical or substantially vertical position.

### BACKGROUND

Plastic parts are commonly made using injection molding, blow molding or extrusion equipment or machines (hereinafter “plasticating machines”). Plasticating machines such as these have been used for decades. Typical plasticating machines used today are relatively large in size (i.e., typically from 3 to 16 feet in length, but sometimes up to 40 feet in length) for increased capacity and throughput, to make multiple parts quickly and efficiently. In most operations, the machine receives polymer or thermoplastic resin pellets in solid form, then heats and works the resin to convert it to a homogenously melted or molten state. The longer the length of the machine, the larger diameter of the extruder bore and the more residence time pellets have for homogenous melting and mixing.

The basic plasticating machine (either extruder or injection molding machine) has an elongated cylindrical barrel heated at various locations along its length. An axially supported and rotating screw extends longitudinally through the barrel. The screw is responsible for forwarding, melting, pressurizing and homogenizing the material as it passes from an inlet port to an outlet port of the barrel. The screw has a root core with a helical flight thereon and the flight cooperates with the cylindrical inner surface of the barrel to define a helical valley forming a path for forward passage of the resin to the outlet port.

In a typical plasticating machine, a feed section extends forward from the inlet port of a feed opening where the solid thermoplastic polymer resin, generally in pellet form, is introduced and pushed downstream by the screw along the inside of the barrel. The resin is then worked and heated in the melt section (also sometimes referred to as a “transition section,” “barrier section” or “compression section”), and the melt or molten material is then passed to a metering section for delivery under pressure through a restricted outlet or discharge port to an extrusion die or injection mold. As described in more detail by Womer et al., in U.S. Pat. Nos. 5,798,077, 5,931,578, 6,488,399, 6,497,508, 6,547,431, 6,672,753 7,014,353, and 7,156,550, it is desirable that the molten material leaving the machine be completely melted and homogeneously mixed, resulting in uniform temperature, viscosity, color and composition. Plasticating machines typically operate at a constant or steady screw speed, usually around 125 revolutions per minute (“rpm”), for consistency, uniformity and continuity of the process.

With the growth of 3D printing, an opportunity has been created to invent and develop a relatively small extruder, appropriately scaled to size that can deliver a consistently uniform and repeatable flow of molten plastic to a printer head at a rate of 20 lbs per hour or less (hereinafter “micro-extruder”). On account of size and area limitations of small and medium size 3D printer (i.e., known as “medium area additive manufacturing” [abbreviated “MAAM” in the industry] having printer dimensions of approximately 5 ft×10 ft×3 ft to “small area additive manufacturing” [abbreviated “SAAM” in the industry] having printer dimensions of approximately 30 in×22 in×23 in), the extruder has weight and length constraints, relatively short heat-resonance limits, feed angle constraints, and confinements for the torque drive mechanism need to control the speeds and torque of the screw, it is not practical to simply scale down a standard plasticating machine for use in 3D printing. Engineering is required. In 3D printing, for example, the extruder must be able to operate at varied screw speeds (e.g., 0 to 400 rpm) during printing. Further, the micro-extruder needs to be designed to process industrial feedstock pellets. More specifically, as extruders get smaller, a problem develops at the feed opening; namely, industry size plastic pellets are too large for the shallow channel depth of the helical valley for passage into and through the feed section.

As a result of these complications, small and medium sized 3D printers (i.e., SAAM and MAAM 3D printers) are forced to use spools of plastic filaments or strands (like weed trim-cord) fed to a printer head. In a typical 3D printer on the market, the filament is fed from a spool to the printer head where it is heated, melted and deposited. With this design, it is critical that each spool has a filament that is uniform in composition and dimension (i.e., usually about 1.75 mm and 2.85 mm in diameter with very close cross-sectional tolerances and pure chemical composition). Otherwise, the deposit rate of molten material is not uniform from spool-to-spool or from beginning-to-end of the spool, and the filament may break during operation. As a result, the 3D printer must be stopped and reloaded. Since filament spools need to meet very close composition and dimensional tolerances, spool costs are substantial and not all thermoplastic polymer resins are available in spool form. In addition, the deposit rate of 3D printers using spools is relatively slow and not ideal for making large printed objects. In summary, spool driven 3D printers are slow, failure prone, labor intensive, expensive to operate, and limited to particular polymer resins.

For 3D printing to become more cost-effective and competitive as an industry tool for manufacturing, a relatively small extruder is needed to replace the spool fed 3D printer head. To be clear, there is a need for a small efficient extruder that is mountable to a 3D printer that can deliver a uniform molten polymer resin to the printer head consistently, uniformly and quickly. Moreover, the extruder is needed that can process commonly available, standard size industrial pellets, in addition to micro-pellets, in a timely, efficient and effective manner, and within a confined space. The instant invention accomplishes this objective, and provides the benefits and advantages discussed infra.

This invention is for a micro-extruder having these advantages and others, including: providing a continuous feed of plastic pellets to the printer head from a larger bulk supply; durability; ease of operation; and optimally sized for convenient mountability and easy interchangeability (namely, with this invention extruders can be interchanged for an optimal barrel and screw design to print a particular polymer resin). Further yet, another advantage includes more optimal control of the deposit rate of molten plastic with changes in the linear speed of the printer head. By way of example, as the printer head approaches a corner to turn, it must slow down, stop, turn and restart. Simultaneously, the deposit rate with this invention may also be slowed, stopped and restarted by controlling the screw's rotational speed. Using spools, it is difficult to stop the spool without overheating and breaking the filament at the printer head, to avoid excess plastic from being deposited during stops and starts.

Yet another advantage of this invention is its reduced cost of operation. To be clear, this invention replaces the spool with commercially available thermoplastic polymer resin pellets most often used in the extrusion industry. Pellet material is seen as superior to spool filament, since spool filament is typically extruded from standard pellets, and thereby exposed to one or more thermal cycles, which causes thermal degradation and molecular breakdown.

Although there are several different types of thermoplastic resins with each having different physical properties and characteristics, the standard industrial size plastic pellet is approximately 0.125″×0.125″. There is also a smaller pellet feedstock known as “micro-pellets” having a size between 0.020″×0.020″ to 0.050″×0.050″. Standard size plastic pellets and micro-pellets are illustrated side-by-side in FIG. 11 to show the relative relationship in size. It should be noted that there are disadvantages of micro-pellets over standard pellets in that many thermoplastic resins are compounded with carbon or glass as fibrous fillers. Fibrous fillers create a stronger finished product, and the longer the fiber, the stronger the product. Because of the size difference, using fibrous micro-pellets will not always work as effectively as standard industrial size pellets with fiber. Further, the cost of micro-pellets is not as attractive as standard size pellets because of the added expense needed to process and screen micro-pellets.

This invention, therefore, is designed to work primarily with standard pellets. However, even with all its disadvantages, using micro-pellets with this invention will work just as well and is still more cost attractive and reliable than spool-fed printers currently on the market.

### SUMMARY OF THE INVENTION

The preferred embodiment of the instant invention includes a single screw micro-extruder mountable to a 3D printer to or near the printer head having a torque drive mechanism. The micro-extruder comprises, in this case, a feed chamber having a conically shaped feed surface converging downwardly at the printer head. The feed chamber has a port/opening for receiving solid plastic pellets. The extrusion barrel, having a length and a longitudinal axis, preferably extends downwardly from the feed chamber and has an inner conically shaped, concentric bore between input and output ends. The bore includes a mouth at the input end and an exit opening at the output end with a melt section in between. The diameter at the mouth is greater than the diameter of the exit opening, and an extrusion nozzle is mounted at the output end of the extrusion barrel.

The micro-extruder in this invention further includes a rotatable screw with a length extending along the longitudinal axis through the conical bore of the extrusion barrel. The screw, supported at a drive-shaft portion by a bearing-seal housing passing through the feed chamber, is rotatably driven by a torque drive mechanism at the printer head. Further yet, the screw includes a root or root core with a surface and a flight located on and projecting radially from the core. The flight has a lead length forming a channel with a helix angle and a helical path between the root core surface of the screw and an inner surface of the conically shaped bore of said extrusion barrel; and the helical path extends from the input end into the melt section of said extrusion barrel, toward the extrusion nozzle.

At the outermost surface of the flight is a land adjacent the inner surface of the conically shaped bore; thereby forming a conical angled profile substantially equal to the conical angle of the barrel, (from the input end through the melt section of the extrusion barrel) such that the flight works closely with the inner surface of the bore to engage and wedgingly urge pellets from said feed chamber downwardly through the extrusion barrel to the extrusion nozzle. The diameter of the root core of the screw (in the direction from the input end toward the output end of the extrusion barrel) is either constant or tapered (i.e., preferably constant, but it may be tapered by increasingly expanding; and in a few applications the root core diameter may decrease slightly), but in all cases it is important that the channel's root depth throughout the helical path decreases for compression of the plastic pellets between the root core surface and the inner surface of the bore for pressurizing melt in the melt section to exit the extrusion nozzle.

Other structural features of the micro-extruder of this invention may include, without limitation, the following additional components incorporated separately or in combination: a) an auger section having a pre-feed flight extending along the screw length in the feed chamber for pushing pellets from the feed chamber into the barrel; b) a shroud enclosure around the feed chamber (with or without inlet and outlet openings to provide flow of a cooling medium therebetween); c) a screw positioning adjustment mechanism for tuning the position of the screw to optimize the clearance between the screw flight and inner surface of the bore of the extrusion barrel; and d) a secondary-port opening (in addition to a top feed opening in the feed chamber) for the addition of an inert gas, liquid color or a secondary polymer to be melted and homogenized during the extrusion process.

As generally described above, the capabilities, advantages and features of this invention include, among others, the following:
the ability to use standard size pellets and/or micro-pellets as original feedstock (In addition to cost advantages discusses above, thermally sensitive resins, such as PVC, ABS, polycarbonate (PC), acrylic (PMMA), lose integrity and gradually break down with each thermal cycle; unlike pellets, filaments are processed from pellets by extrusion to form spools and this additional thermal cycle denigrates compositional properties for these resins);
with the preferred vertical and rotated off-vertical orientation of the extruder, pellets freely flow by gravitation from the feed chamber into the mouth of the screw (in addition, an auger section having a pre-feed flight extending along the screw length in the feed chamber can be used to urge pellets from the feed chamber into the barrel);
the conical shape of the barrel bore provides a larger feed depth (i.e., channel root depth) at the mouth of the barrel to accept standard pellet sizes for transport and transition to a melt at the discharge end of the extruder having a shallower depth;
the speed of the screw controls throughput rates needed for smaller applications and/or to change the discharge rate of melt at corners and/or as the printer head slows linearly and accelerates;
the angle of the converging conical screw and barrel of the instant invention is changeable in design to better process and/or blend polymer resins having different chemical properties, including viscosity and shear;
the screw channel root depth and screw geometry of the instant invention can be optimized with relatively small dimensional changes to provide better melt homogeneity of the polymer resin being processed;
the feed chamber may be made with ceramic, phenolic resin or similar material having low thermal conductivity with a high or no melting point, or, in the alternative, a thermal resistant insert may be used to provide a thermal barrier between the feed chamber and input end of the extrusion barrel (with these designs intended to insulate the feed chamber from the heat of the barrel so that pellets are not pre-melted in the feed chamber);
holes may be included in the phenolic and/or other low thermally conductive feed chamber of the extruder, or with the alternative embodiment (i.e., using the thermal resistant insert) the feed chamber may be made of a thermally conductive material and designed to have fins to provide for the flow of ambient air or pre-heated air to either cool or pre-heat pellets as the process requires (e.g., the cooling process assists in keeping the pellets from sticking together and the pre-heating process assists in drying or adding additional energy to facilitate melting of the processed polymer resin);
a temperature controller with heating elements is used in the instant invention (attachable to the barrel of the micro-extruder and preferably operational using 120 v AC);
different extruders can be used and easily changed for different polymer resins needed for various 3D printed products;
the plasticizing screw is preferably rotatable using different types of torque-drive mechanisms, such as an air motor, gear motor (AC or DC), or using the spindle head of a CNC machine tool;
the feed chamber may be arranged on the single screw micro-extruder so that the micro-extruder functions in a horizontal position;
the extrusion nozzle at the end of the extruder may be changed to have different orifice sizes to control volumes and shapes of molten extrudate exiting the extruder;
a conduit may be used to supply the feed chamber with pellets from an even larger bulk source;
during the 3D printing operation using this invention, the extruder of the printer head may be rotated to different off-vertical orientations with the torque-drive mechanisms described herein (e.g., if the extruder is attached to the spindle head of a CNC machine tool, the spindle head can operate the extruder at an off-vertical orientation), without loss of pellets by closing the top of the feed chamber and/or without pre-melting of pellets against the screw in the feed chamber by using a sleeve-shield describe infra;
an insulated blanket is preferably used around the resistant heater to reduce the radiant heat emitted from the micro-extruder; and
a relatively continuous and uninterrupted supply of molten plastic is supplied at the printer head at variable rates of deposit to make small to relatively large objects in a more timely and efficient manner than current delivered.
   Moreover, the micro-extruder of the instant invention is designed with features described herein that can be arranged in various combinations, to process a wide range of polymer resins in a cost-effective, efficient, timely, and optimized manner.

### BRIEF DESCRIPTION OF THE DRAWINGS

The drawings are designed for the purpose of illustration only and not as a definition of the limits of the instant invention, for which reference should be made to the claims appended hereto. Other features, objects and advantages of this invention will become even clearer from the detailed description of the preferred embodiment infra made with reference to the drawings in which:

FIG. 1 is a sectional view of the first embodiment of the invention;

FIG. 2A is a view taken along lines 2A-2A of FIG. 1;

FIG. 2B is a cross sectional view taken along lines 2B-2B of FIG. 1;

FIG. 3A is a front illustrational view of a temperature controller usable in this invention and mounted to the extruder as illustrated in FIG. 1 (although the extruder controls may be integrated into a master control system);

FIG. 3B is a depiction showing the rotational range of motion of the extruder from the vertical position illustrated in FIG. 3A to rotations in multiple directions of 30 degrees, 60 degrees and 90 degrees (without limitation to incremental rotations therebetween);

FIG. 4A is a side view of the first embodiment the conical screw shown in FIG. 1;

FIG. 4B is a cross sectional view of the conical screw taken along lines 4B-4B of FIG. 4A;

FIG. 5A is a sectional elevational view of a conical barrel shown in FIG. 1;

FIG. 5B is a cross sectional view of the conical barrel taken along lines 5B-5B of FIG. 5A;

FIG. 6 is an illustration of an embodiment of the invention (shown held by a printer holding arm) using a servo-motor as the torque drive mechanism, with the feed chamber having a design different than that shown in FIG. 1, described below with reference to FIG. 6A;

FIG. 6A, moreover, is a sectional elevational view of the invention showing the feed chamber in FIG. 6 secured to the conical barrel with a heat resistant insert for thermal insulation between the chamber and the barrel.

FIG. 7 is an elevational view illustrating an alternative embodiment to that shown in FIG. 6 with shroud enclosure around the feed chamber and having an elongated opening in the shroud for exhausting compressed air, in this case, used as the cooling medium;

FIG. 7A is a sectional view (similar to FIGS. 1 and 6A) taken along line 7A-7A of FIG. 7, showing the screw in this case having an auger section extending along the screw length into the feed chamber for pushing pellets from the feed chamber into the barrel;

FIG. 8 shows the screw in FIG. 7A with the auger section embodiment;

FIG. 9 illustrates additional component in the invention, including a secondary-port opening for adding to the feed chamber, and a shim/spacer between a bearing-seal housing and the feed chamber as the screw positioning adjustment mechanism for tuning the position of the screw to optimize the clearance between the screw flight and inner surface of the bore of the extrusion barrel;

FIG. 10 illustrates yet another embodiment of the invention (i.e., different than that shown in FIG. 6) wherein the drive mechanism is mounted lateral and parallel to a longitudinal axis of the conical screw and coupled using a pulley and belt system (as opposed to a rigid and aligned coupling shown in FIG. 6); and

FIG. 11 is an illustration of standard industrial size plastic pellets and micro-pellets described in the Background section.

The particular embodiment illustrated in the Figures show dimensions. The dimensions are not included to limit the scope of the invention to those particular measurements. The dimensions are useful, however, for scaling the preferred embodiment described below.

### DESCRIPTION OF THE PREFERRED EMBODIMENT

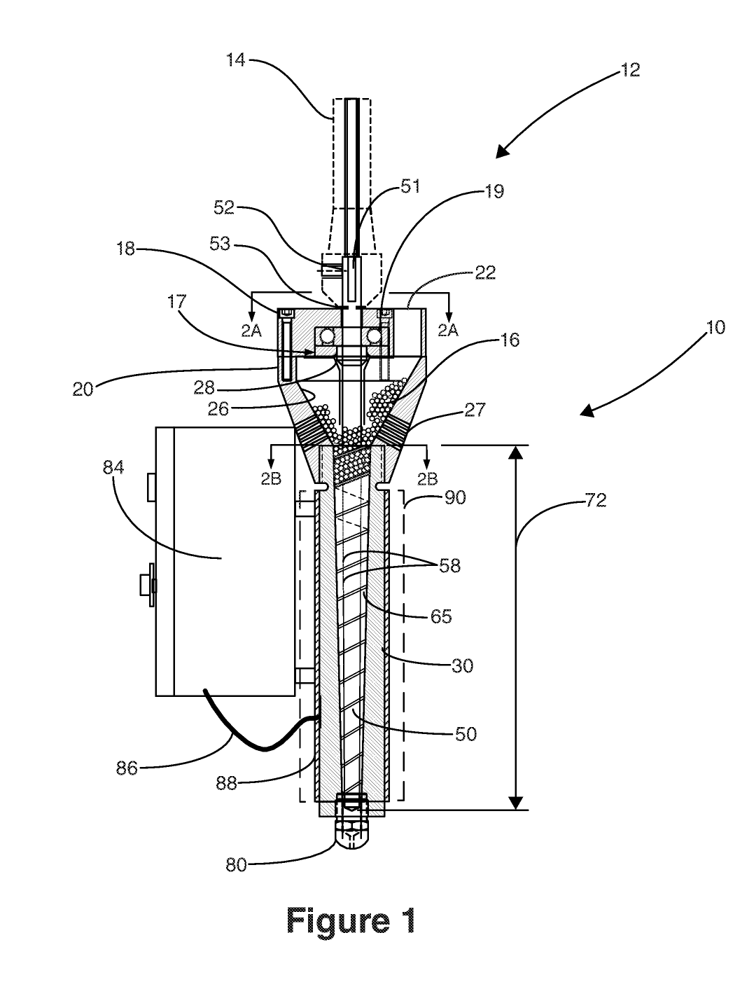

With reference to FIG. 1, a single screw micro-extruder 10 in this case is designed for processing plastic granules or pellets of resin for printing using a 3D printer. The micro-extruder 10 is relatively small (i.e., preferable 24 inches or less in length, and more optimally about 15 inches for an output of between 2 to 12 lbs per hour) and easily mountable to a spindle or other torque drive providing mechanism 14, such as an electric gear motor or air motor, at a printer head 12. The apparatus includes a cylindrical extrusion barrel 30 having a length 34, a longitudinal axis 33 extending downwardly from a feed chamber 20 and an inner conically shaped bore 35 along said axis of the barrel 30. The conically shaped bore 35 includes input and output ends (32, 38, respectively) with a conical angle of the bore “x” therebetween. The bore further includes a mouth 31 at the input end 32 and an exit opening 39 at the output end 38 with a melt section 36 therebetween. A diameter 40 at the mouth is greater than a diameter 42 of the exit opening, so that the conically shaped bore tapers inward from the input end to the output end. A screw 50 having a length is rotatably supported along the longitudinal axis 33 through the conical bore 35 of the extrusion barrel 30.

In the preferred embodiment, for example, the extrusion barrel 30 has an outside diameter of about 1.75 inches, a length 34 of about 10 inches (with the length of the melt section 36 being about 9 inches); the bore diameter 40 at the mouth of the barrel 30 (i.e., at the input end 32) is about 1 inch; and the diameter at the output end 38 is about 0.6 inches (to accommodate the nozzle tip threads 82 for nozzle 80).

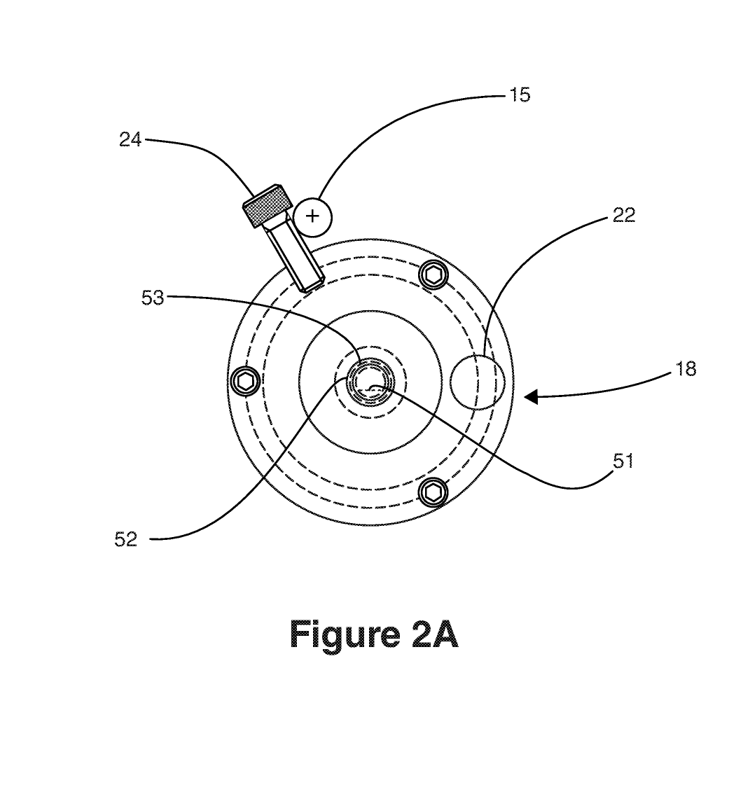

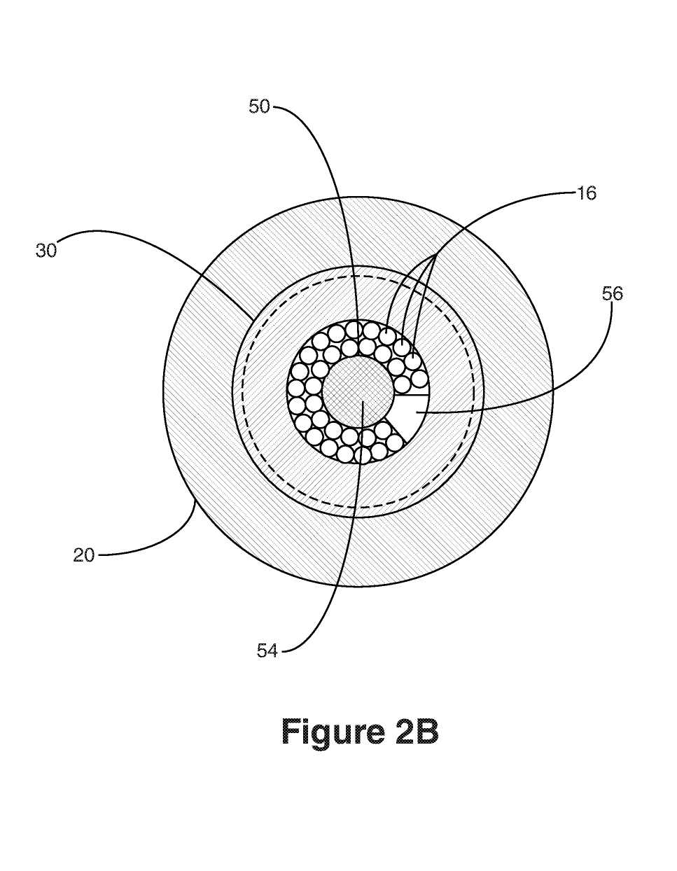

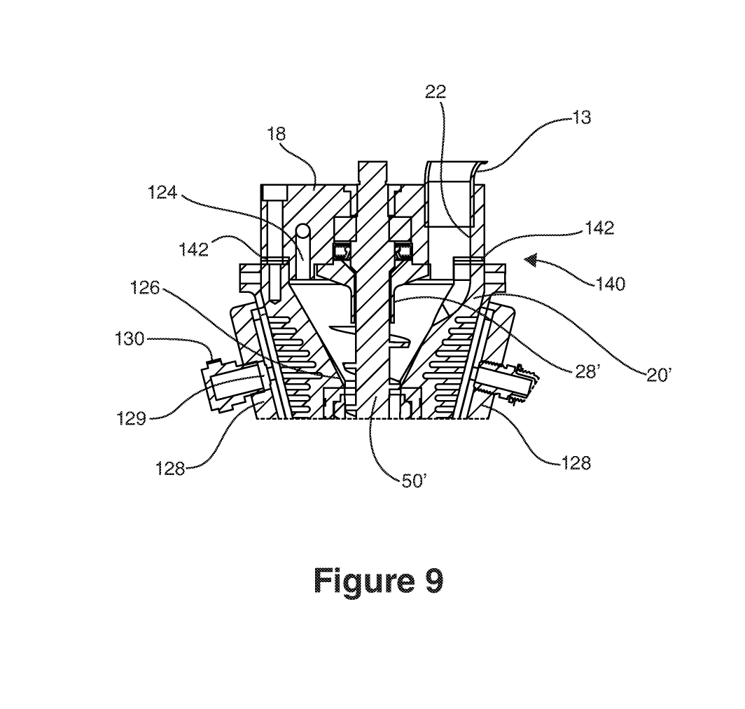

A feed chamber 20 is preferably connected (via threads) to the outside of the input end 32 of the barrel 30, and includes a primary feed opening or fill-hole 22 at the top for receiving solid plastic pellets 16 (preferably via a feed tube or conduit 13 attached to a bulk supply of pellets) as seen in FIGS. 1, 2A, 3A and 3B. In addition, the feed chamber 20 can be connected to a secondary supply at a bore 124 passing through the bearing-seal housing 18 (shown in FIG. 9) or the wall of the feed chamber 20, for the addition of a port/feed inlet for an inert gas, liquid color, UV stabilizer, or second polymer to be melted and/or homogeneous mixed during the extrusion process. Further yet, the feed chamber can be made interchangeable using a two-piece feed chamber assembly bolted together to provide different feed slopes, primary and secondary opening sizes, feed angles, etc. The feed chamber 20 can also include fins 29 (as seen in the alternative feed chamber 20′ design described infra).

The feed chamber is shaped with a conical surface 26 converging downwardly to flood feed the solid plastic pellets 16 to the mouth 31 of the extrusion barrel as shown in FIG. 1. The feed chamber 20 may be made of a phenolic resin or similar material with low thermal conductivity to create an insulting barrier from the heat of the barrel (i.e., while pellets 16 are being conveyed and melted), so that pellets 16 are not pre-melted in the staging area of the feed chamber. Axial grooves 126 on the tapered conical surface 26 of the feed chamber 20 can be used for friction to assist and improve the feeding of the standard size pellets. The number of grooves 126 and groove geometry will depend on the size, shape and type of pellets 16 being processed. To be clear, the grooves 126 are preferably axially located on the lower portion of the taper on the inside of the feed chamber 20 as seen in FIG. 9. Pitting (via sandblasting or grinding) may also be used, with or without the grooves 126, for roughening the conical surface 26 to increase friction even more.

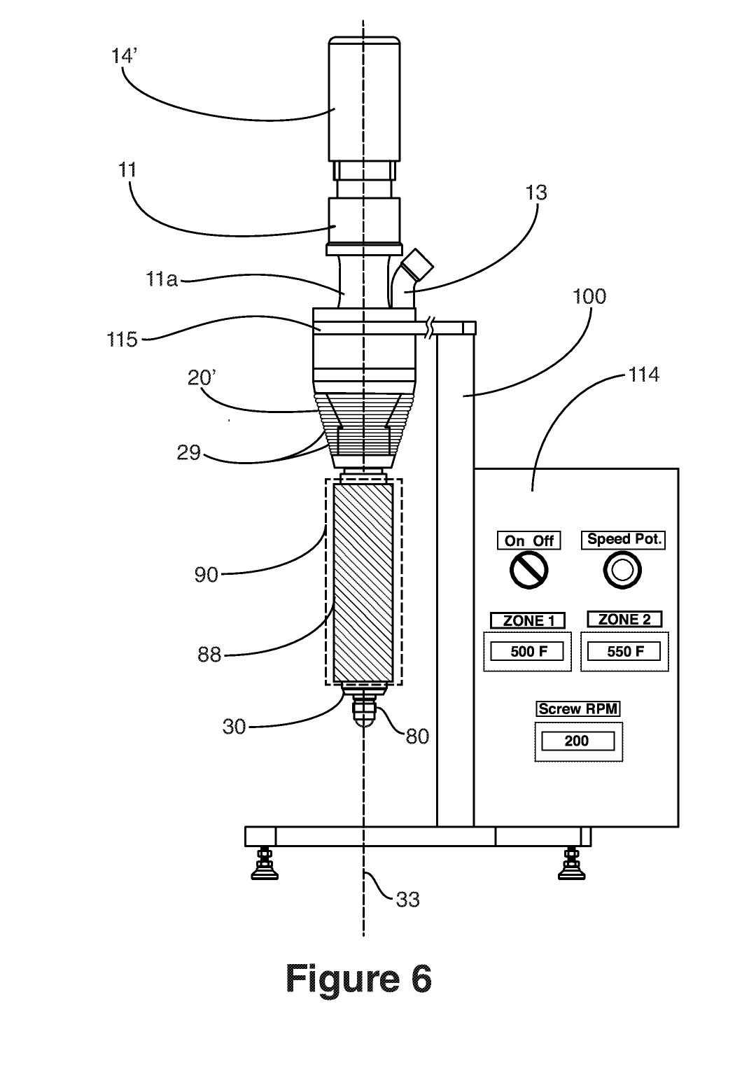

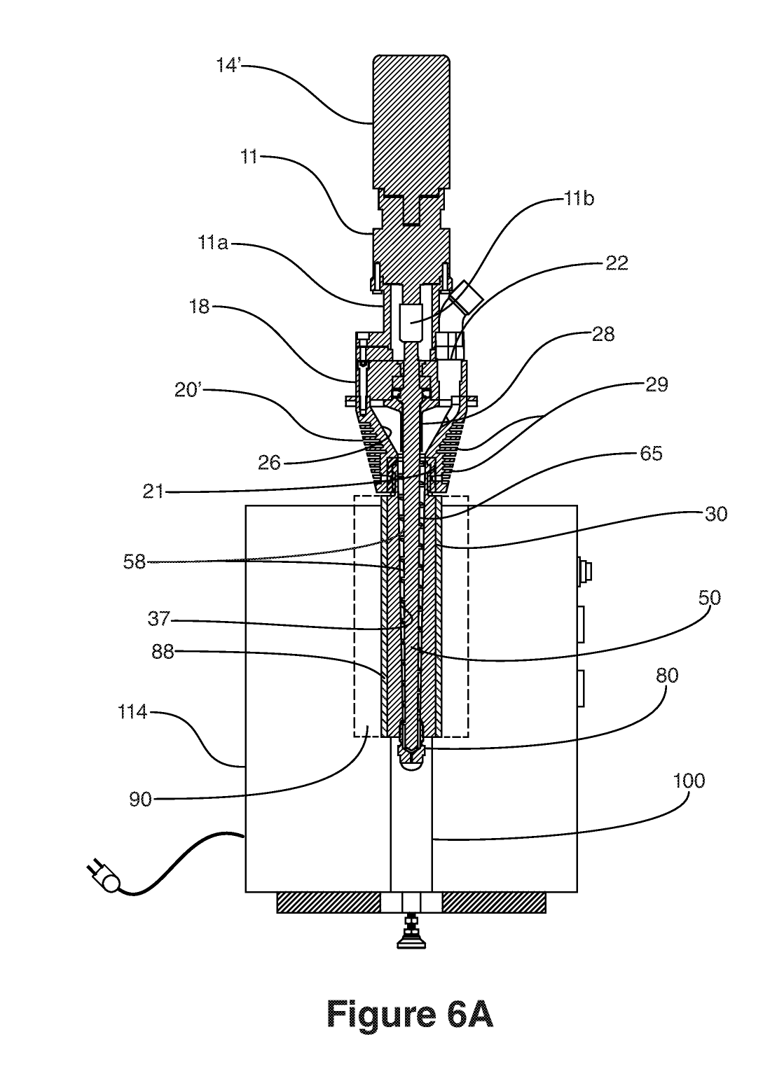

Still further, small holes 27 through conical surface 26 of the feed chamber 20 may be used to provide a pathway for ambient air or pre-heated air to either cool or pre-heat the pellets 16 as the process may require (e.g., the cooling process will further assist in keeping the pellets from sticking together and the pre-heating process will assist in drying or adding additional energy to facilitate melting). In the alternative, a thermal resistant insert 21 (shown in FIG. 6A) may be used to provide a thermal barrier between the feed chamber 20 and input end 32 of the extrusion barrel 30. The thermal insert 21 can be threaded and/or chemically bonded therebetween. With this design, the thermal resistant insert 21 is preferably made of a phenolic resin, ceramic or similar material with low thermal conductivity and the feed chamber 20 is made of a thermally conductive material such as aluminum. In addition, the alternative feed chamber 20′ may include fins 29 as shown in FIGS. 6 and 6A, to dissipate escaping heat passing through the thermal insert 21 barrier, along the length of the screw 50, and/or radiating from either or both of said sources.

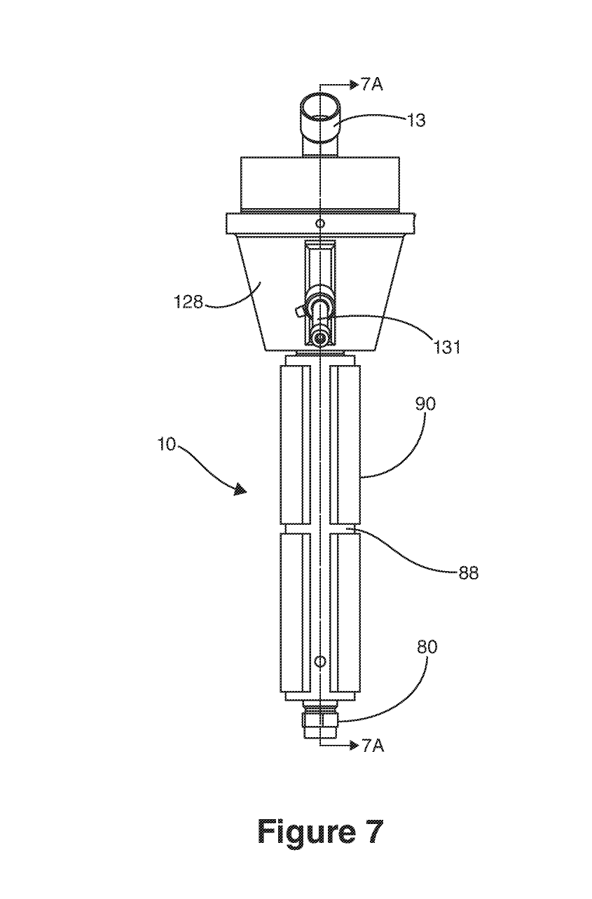

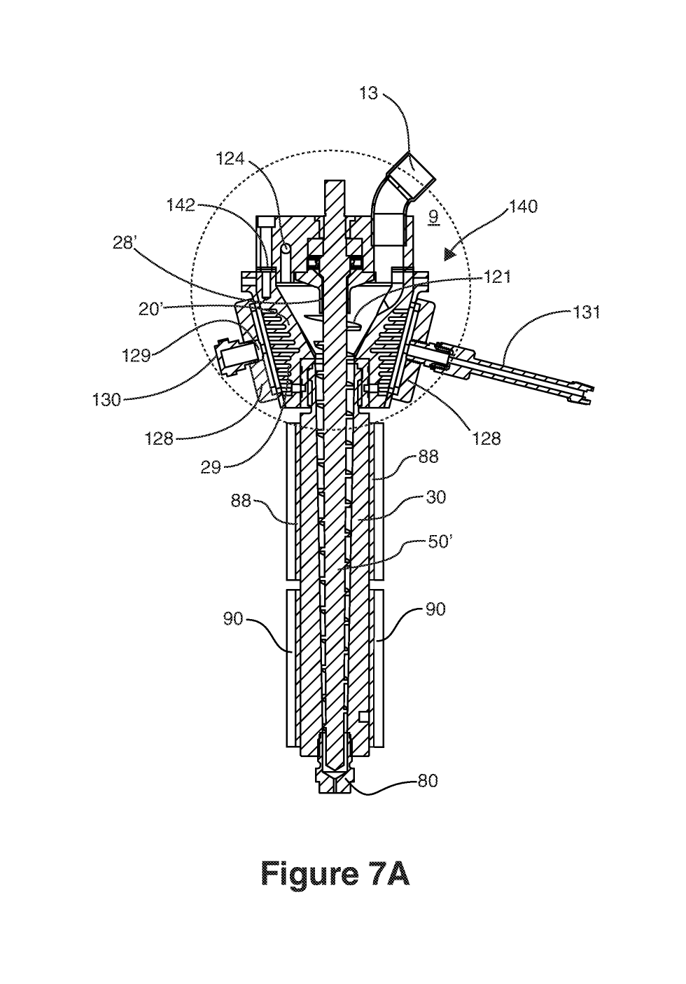

Also, the feed chamber 20 or 20′ can be enclosed with a feed chamber shroud 128 to enclose the feed chamber (as shown in FIGS. 7, 7A) to contain a cooling medium compressed (e.g., air or chill water) medium forced therebetween. The feed chamber shroud 128 would have inlet and outlet openings to supply the cooling medium. More specifically, FIG. 7 shows opening 129 to exhaust compressed air, fed via a pressurized air vortex 131 from the opposite side to regulate the flow rate for cooling about the feed chamber 20 or 20′. An air outlet muffler 130 is preferably threaded at the opening 129 to muffle the sound and force of the escaping air.

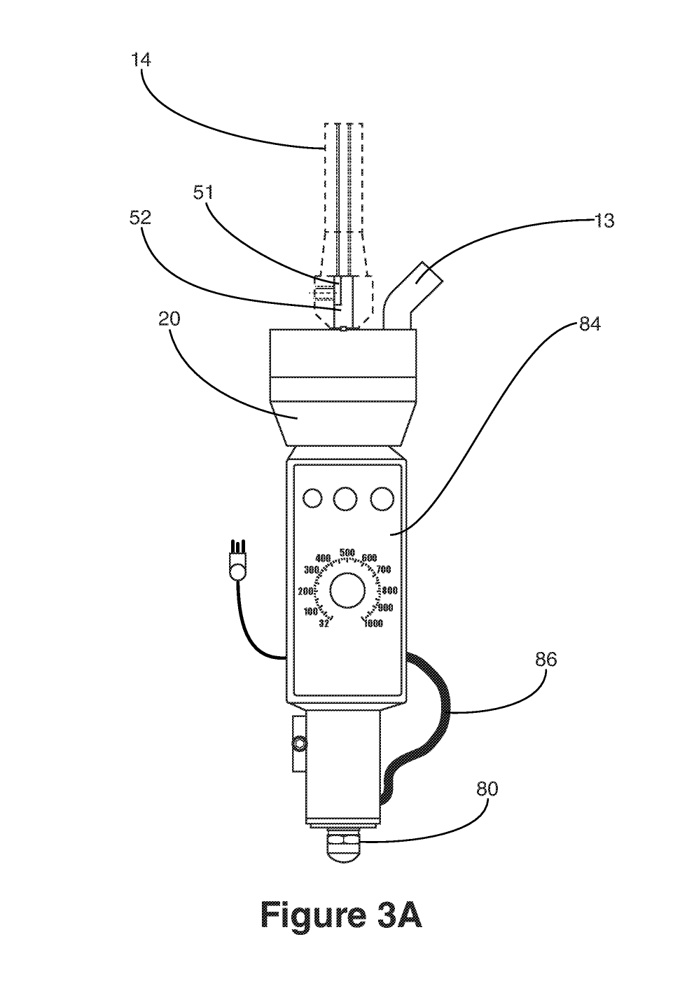

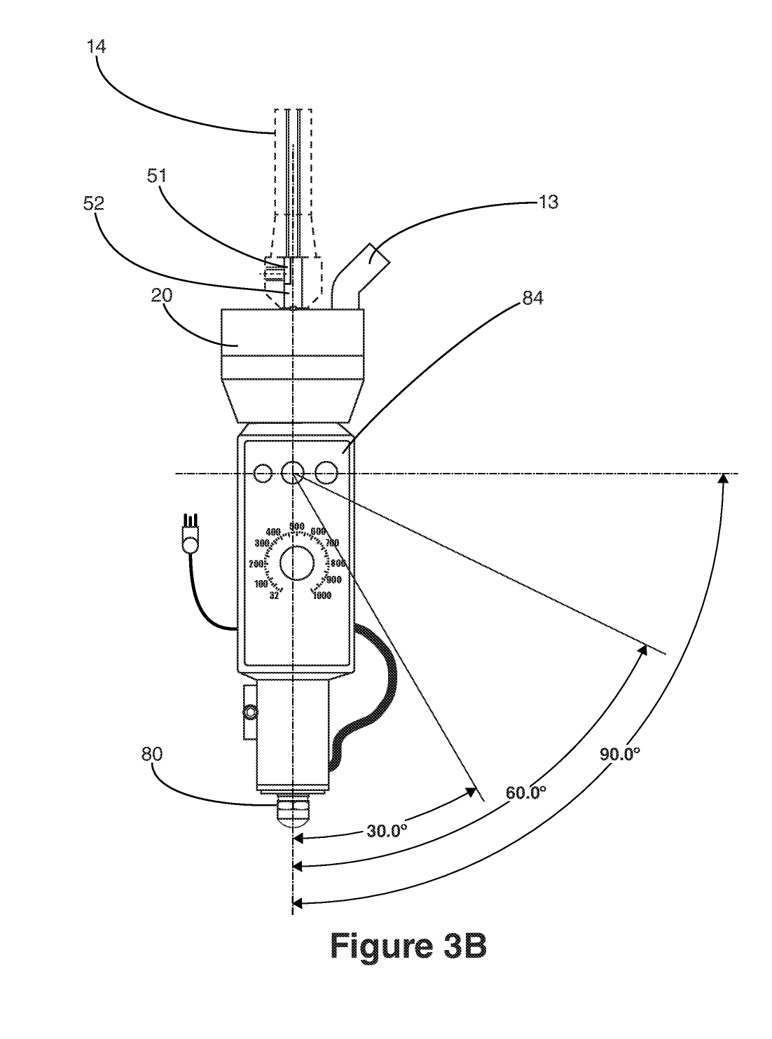

Further yet, the feed chamber (either 20 or 20′) may include a sleeve-shield 28 spaced from the drive-shaft portion 52 of a screw 50 (described infra) to shield the neck of the drive-shaft portion 52 from direct contact with pellets (i.e., again, to prevent pre-melting in the feed chamber caused by heat transferring up the screw during operation). Also, air can be circulated along the length, i.e. inside of the sleeve-shield 28 and the drive-shaft portion 52, for additional cooling or pre-heating as the case may be. The space therebetween is particularly important to prevent pre-melting when the extruder is rotated by the mounting arm 115 of the extruder mounting frame 100 from the off-vertical position during the 3D printing operation as shown in FIG. 3B.

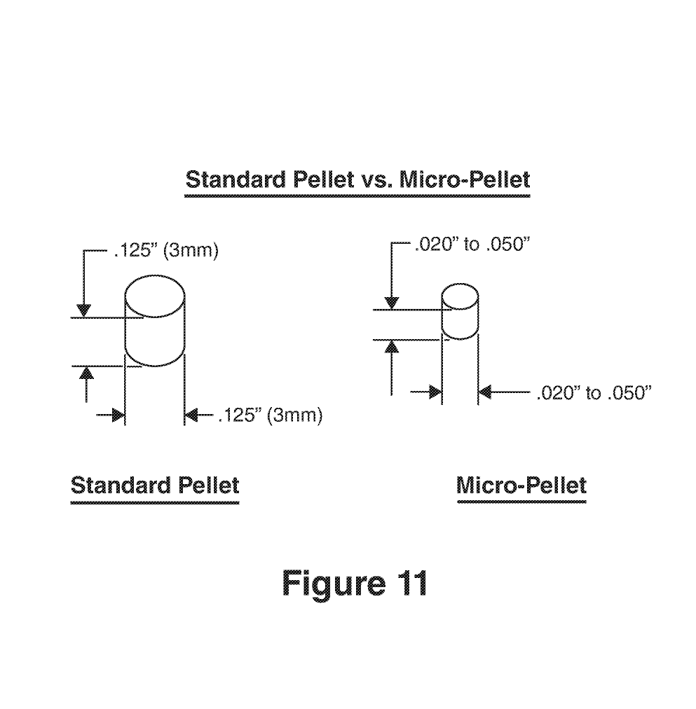

Regarding the screw 50 in this invention, a single, rotatable screw 50, having an overall length 70, is positioned along the longitudinal axis through the conically shaped bore 35 of the barrel 30. The overall length 70 of the screw 50 is preferably about 15 inches when used with the preferred 10 inch barrel described supra. As depicted in alternative configurations shown in FIGS. 1, 6A, and 11, the screw 50 is preferably attachable to a torque drive mechanism 14 of the printer head 12 for rotation. Moreover, the torque drive mechanism 14 may be an air motor, a gear motor (AC or DC), or the spindle head of a CNC machine tool. With reference to FIGS. 6 and 6A, the drive mechanism 14 shown therein is a servo-drive gear motor 14′ having a gear reducer 11, gear reducer adaptor 11a, and coupling 11b aligned along longitudinal axis 33. The speed of the drive mechanism is preferably controlled using a servo-controller with tachometer (see that the servo-controller and temperature controller may be combined in a single system controller 114).

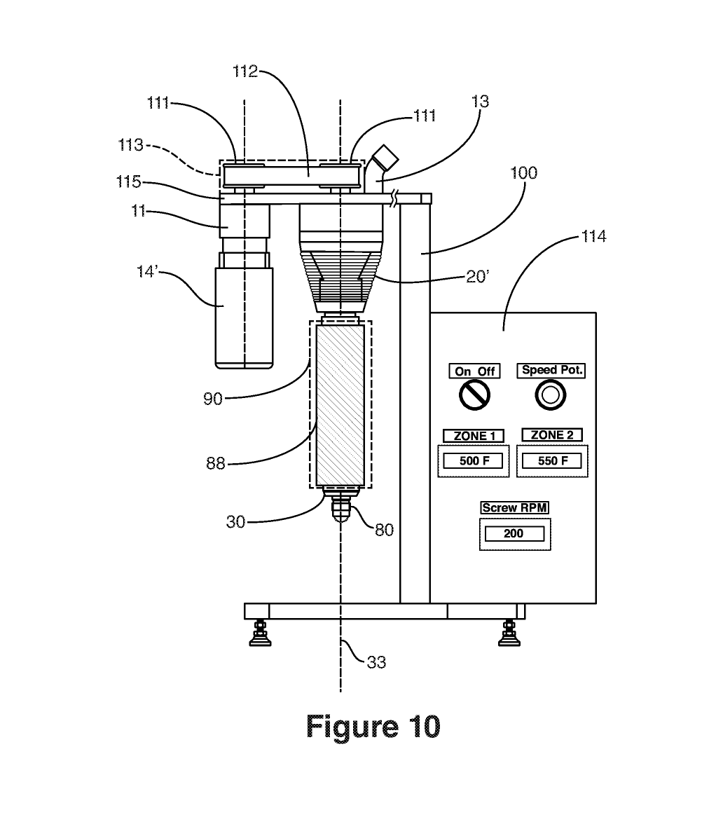

To reduce the height of the overall system and eliminate the adapter 11a and rigid mechanical coupling 11b between the drive mechanism 14′ and screw 50 shown in FIGS. 6 and 6A, FIG. 10 illustrates an alternative design wherein the drive mechanism 14′ is mounted lateral and parallel to the longitudinal axis 33. Accordingly, the center of gravity of the micro-extruder 10 is lowered. As a result, unwanted movement and vibration of the extruder are reduced at stops, starts and accelerations during print travel. Moreover, it improves stability and, therefore, the precision of the printed molten extrudate or melt plastic at greater print speeds. In this design, the drive mechanism 14′ is secured adjacent the feed chamber 20 or 20′ via mounting arm 115. The embodiment shown in FIG. 10 is driven by a pulley/belt system (i.e., pulleys 111 and a belt 112) covered by a belt-pulley guard 113. Preferably the pulley/belt system uses a cog pulley and cog belt to eliminate slippage, yet provide less rigidity than the rigid coupling 11b shown FIG. 6A. Alternatively, the pulley/belt system can be replaced using gears and/or the drive mechanism 14′ may mounted lateral and perpendicular to the longitudinal axis 33.

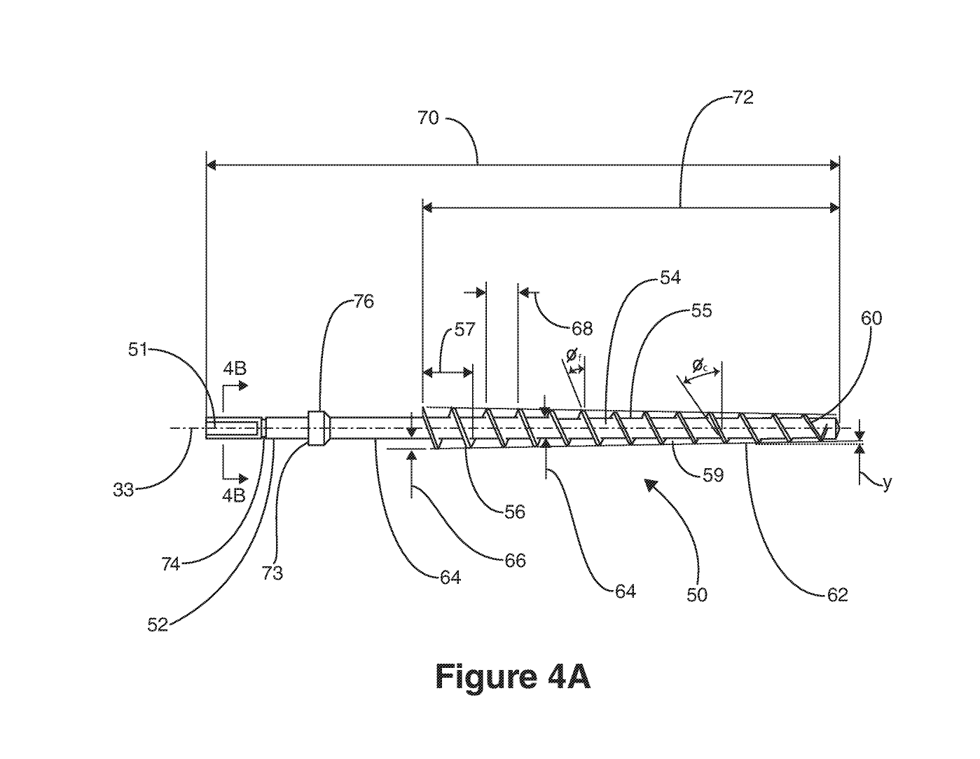

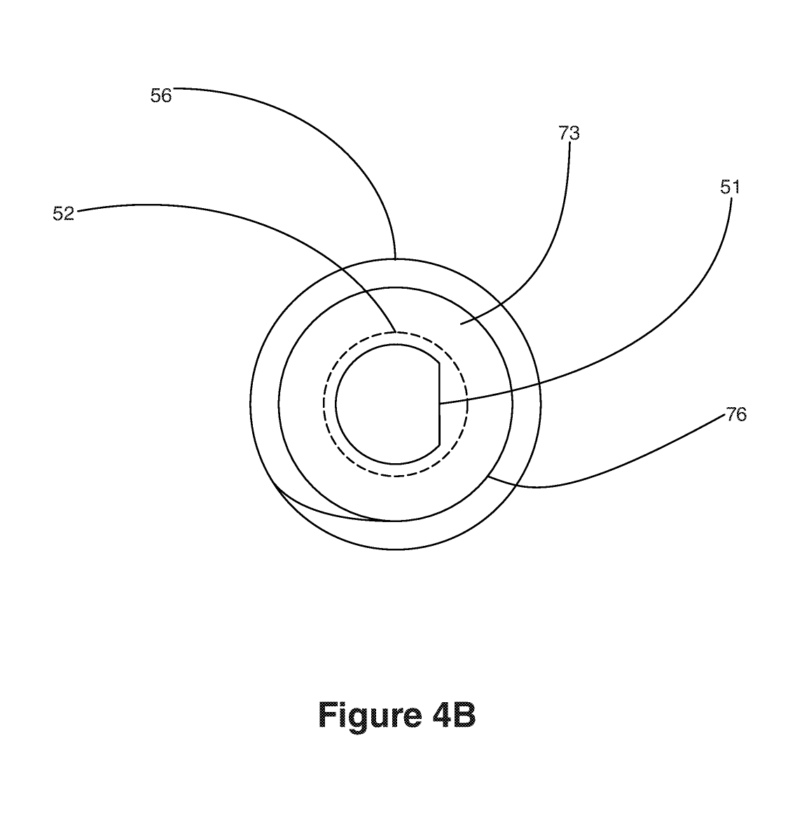

The screw 50 is easily attachable to the torque drive mechanism 14 using a drive set-screw and flat-face section 51 for a quick connect or disconnect at the drive-shaft portion 52 of the screw shown in FIG. 4A (see, for example, FIG. 1). Regarding the alternative torque drive mechanism 14′, the set-screw and flat-face section 51 will also provide a quick connect/disconnect to secure coupling 11b or pulley 111 for the embodiments shown in FIGS. 6 and 10, respectively. Using a snap ring 53 fitted in a snap ring groove 74, the screw 50 can be positioned and held axially with reference to the barrel 30, to maintain clearance between a land 60 of the screw flight 56 and the inner surface of the bore 37 of the barrel's conical bore 35 as described in detail infra. This clearance is preferably between 0.002″ to 0.012″ total or 0.001″ to 0.006″ per side.

The drive-shaft portion 52 of the screw 50 passes through the feed chamber 20 or 20′ and is mounted for rotation through a bearing-seal housing 18 having an angular contact bearing 19 and a lip-seal 17 (i.e., contacting the screw's thrust load surface 73 and lip-seal surface 76, respectively) as best seen in FIGS. 1, 4A and 4B. The bearing-seal housing 18, or in the alternative, the barrel 30 includes an anti-rotation mechanism 24 (such as a bolt, arm or bracket) to secure the barrel 30 from rotation (caused by rotation of the screw 50 during operation) using brace 15 at the printer head 12.

Other preferred features of the screw 50 include a root or root core 54 with a root core surface 55 having a flight 56 projecting radially from the core. In the preferred embodiment of this invention, the screw has a constant diameter 64 at the root core 54 (see, FIG. 4A) of about 0.5 inches relative to the screw's overall length 70 of about 15 inches and barrel length 34 of about 10 inches as describe herein for the preferred embodiment (these dimensions, however, are relative and may be adjusted to accommodate the different melting properties of various plastics, screw configurations for mixing, print speeds, extruder weight requirements, etc.). The flight 56 winds at a lead or lead length 68 around the root core 54, typically in a right hand threaded direction at a helix angle “θ,” defining a helical valley 65 forming a channel 59 with helical path 58 bound by the flight 56, the root core surface 55 of the screw, and (at the barrel 30) an inner surface of the bore 37 of the conically shaped bore 35 of said barrel 30. The helix angle “θ” may be either constant or variable depending on the particular geometry of the screw 50 and the place of measurement. More specifically, the helix angle “θ” is equal to the inverse tangent of the lead length 68 at the place of measure (i.e., the axial distance of one full turn in the channel) divided by the circumference at the point of the screw 50 where the helix angle “θ” is being measured. For reference, using the preferred dimension described herein, the lead length 68 would be preferably 0.75 inches.

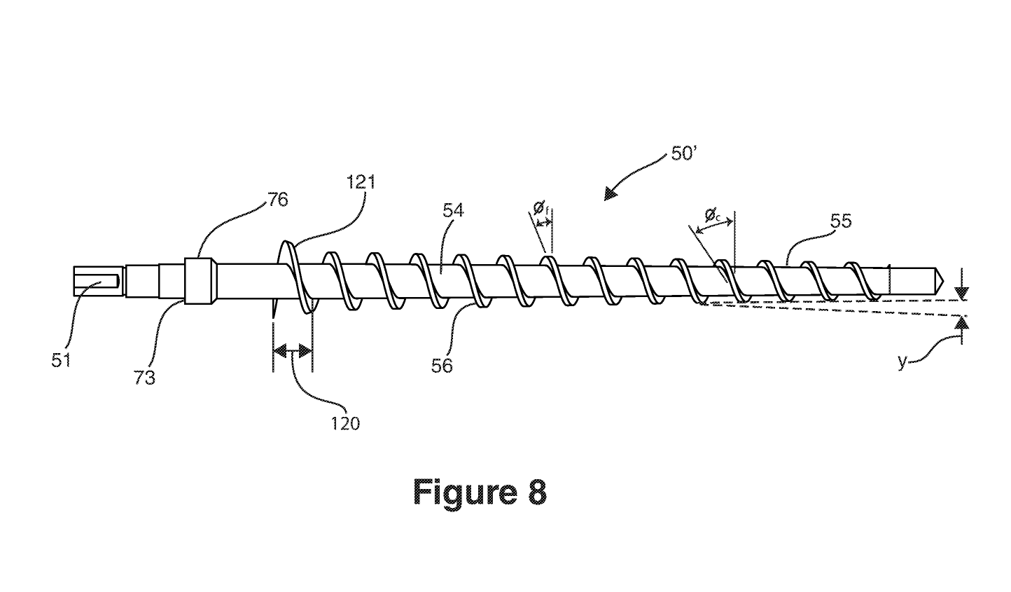

An auger section 120, having a pre-feed flight 121 (shown in screw 50′ illustrated at FIGS. 7A, 8) extending along the screw length 70 in the feed chamber 20 about 0.5 to 1.5 turns (preferably 1 full turn), can be added to push the otherwise gravitationally fed pellets 16 into the barrel 30. The depth of the helical valley 65 is preferably increased and the helix angle “θ” of the flight 56 in the auger section 120 should be engineered to optimally accommodate the shape, size, and density of the bulk pellets, with reference to the shape, slope and depth of the feed chamber 20, 20′, position and size of the primary and secondary feed-openings (22, 124, respectfully), and desired speed of the 3D printer. The length of the sleeve-shield 28 may have to be shortened to avoid the pre-feed flight 121 of the auger section 120, as best seen by comparison of FIG. 7A (see, sleeve-shield 28′ with the auger section) versus FIGS. 1, 6A (see, sleeve-shield 28 without the auger section).

Once in the barrel 30, the outermost surface of the flight (i.e., the flight land 60) is aligned substantially adjacent to the inner surface of the bore 37 of the conically shaped bore 35, thereby forming a conical profile 62 of the screw having a conical angle “y”. As a result, the helix angle “θ_{c}” measured at the root core is different than the helix angle “θ_{f}” measured at the flight land 60. (See, pg. 39-41 of Engineering Principles of Plasticating Extrusion by Tadmor & Klein, published by Van Nostrand Reinhol (1970)). In the preferred embodiment of this invention, the helix angle “θ_{c}” measured at the core would be constant along the screw's flight length 72 since the root core diameter 64 is constant. However, since the conical profile 62 of the screw changes as the diameter tapers inward toward the axis when measured at the flight land 60, the helix angle “θ_{f}” varies along the screw's flight length 72.

In this case, with the exception of the pre-feed flight of the auger section 120, the helix angle “θ_{c}” at the root core 54 is preferably between about 20 to 30 degrees. The optimum angle helix “θ_{c}” is at about 25.5 degrees. Further, the helix angle “θ_{f}” measured at the mouth 31 of the input end 32 of extrusion barrel 30 is preferably between 12 to 15 degrees, with the optimum angle “θ_{f}” at about 13.5 degrees; and helix angle “θ_{f}” measured at the exit opening 39 of the output end 38 of extrusion barrel is preferably between 20 to 23 degrees, with the optimum angle “θ_{f}” at about 21.7 degrees. The average helix angle “θ_{f}” of the conical profile 62 of the screw is preferably between 16 to 19 degrees, with the optimum average “θ_{f}” at about 17.5 degrees.

It is important to note that the screw root core 54 inside the barrel in other embodiments can be tapered, in which case, if the tapered root core diameter 64 closely corresponds with the taper of the conical profile 62 discussed above, the helix angle “θ_{c}” will proportionally vary like that of the helix angle “θ_{f}” (i.e., in accordance with the changing circumference of the root core using the formula for the helix angle “θ” discussed supra).

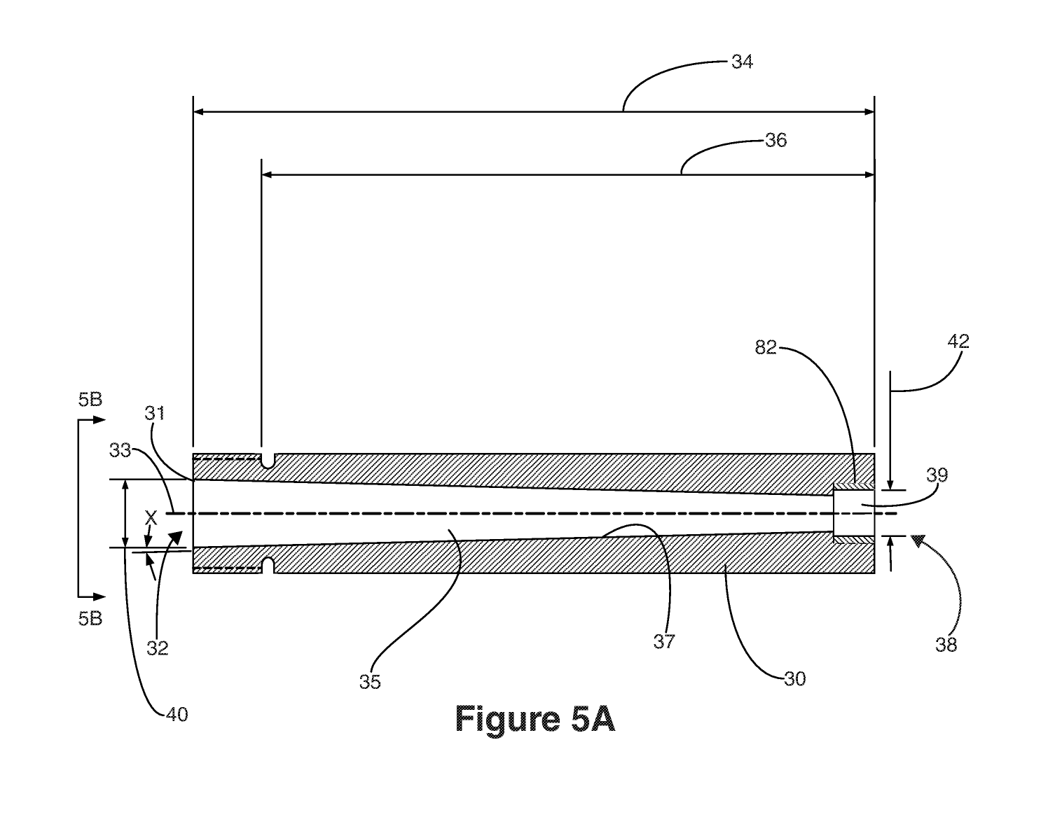

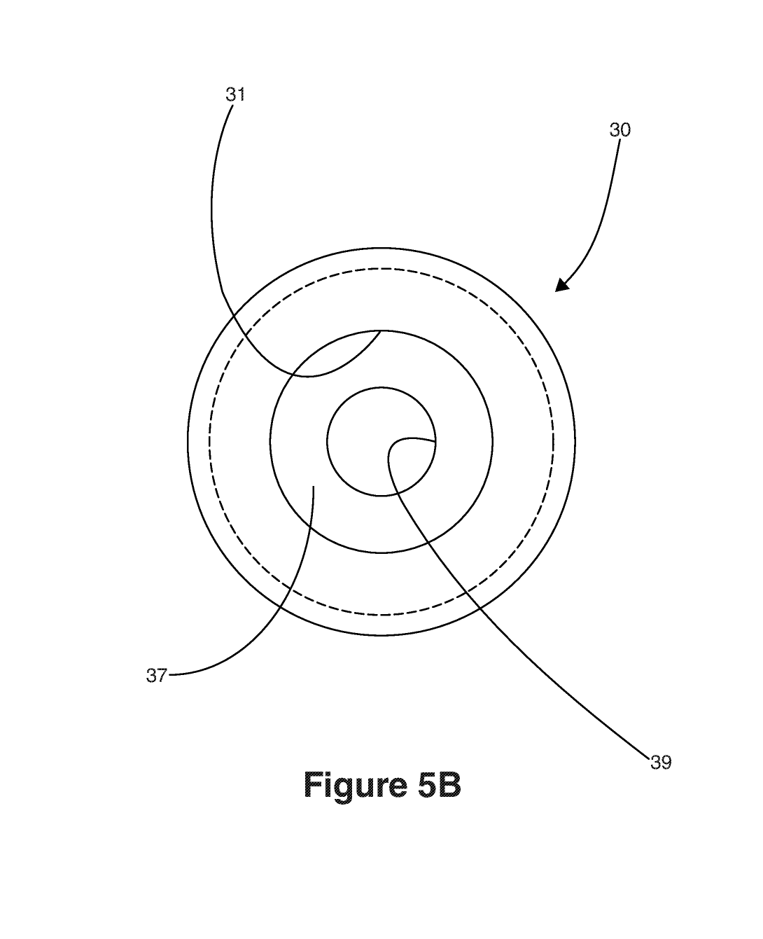

With reference to FIGS. 1, 4A and 5A, the helical path 58 in this case extends from the input end 32 of the barrel 30 into the melt section 36, toward an extrusion nozzle 80 for the discharge of plasticated molten extrudate or melt for printing. The extrusion nozzle 80 is threadably attached at the end of the barrel 30 by nozzle tip threads 82. With the flight land 60 in close proximity, adjacent the inner surface of the bore 37 of the conically shaped bore 35 (whereby the conical angle “y” of the screw's profile 62 is substantially equal to the conical angle “x” of the barrel bore), the flight 56 works closely with the inner surface of the bore 37 of the bore to engage and wedgingly urge pellets 16 from said feed chamber 20, 20′ downwardly through said extrusion barrel to the extrusion nozzle. More specifically, the flight land 60 moves in close cooperative proximity with the inner surface of the bore 37 of the conically shaped bore 35 such that the clearance is preferably between about 0.001″ to 0.006″ per side. Too much clearance causes leakage over the flight 56 and, therefore, loss in throughput rate.

A screw extension adjustment 140 is preferably included with this invention for setting the position of the screw 50 along the longitudinal axis 33 of the extrusion barrel 30 for optimal clearance between the screw flight 56 and inner surface of the bore 37 of the barrel. In this case, a spacer, such as a shim 142 (best seen in FIG. 9 between the bearing-seal housing 18 and the top of the feed chamber 20), is used. Alternatively, the shim 142 may be inserted above or below the lip-seal 17 to space the screw 50 relative to the inner surface of the bore 37. Yet another alternative design includes a fine adjustment of the barrel 30 along the longitudinal axis 33, relative the feed chamber 20, made by screwing or unscrewing the barrel 30 from the feed chamber 20 at the threaded fitting therebetween described above (i.e., the threaded connection of the feed chamber 20 to the outside of the input end 32 of the barrel 30 seen in FIG. 1).

Further describing the screw 50, with either a constant or tapered diameter 64 of the screw's root core 54, the channel's root depth 66 is continually decreasing through the helical path 58 (i.e., in a direction from the input end 32 toward the output end 38 of the extrusion barrel). With reference to the channel root depth 66 (i.e., the depth of the helical valley 65, measured radially from the root core surface 55 to the inner surface of the bore 37 of the barrel 30), the decreasing channel root depth 66 in the helical path 58 creates compression of the plastic pellets 16 between the root core surface 55 and the inner surface of the bore 37 of the conically shaped bore 35 to pressurize the melt section 36 of said barrel 30 before the extrusion nozzle 80.

As used herein, the term “compression ratio” means the ratio of the volume of material held in the first channel at input end 32 to the volume of material held in the last channel at the output end 38 before exiting the extrusion nozzle 80. Preferably, in this invention the “compression ratio” is between about 3 to 7, with the optimum ratio at about 5. For example, using the dimension of the barrel 30 and screw 50 described above with reference to the preferred embodiment shown in FIG. 1, the channel root depth 66 at the input end 32 is at least 0.25 inches and the channel root depth at the output end 38 is about 0.05 inches. Of course, these dimensions would need to be adjusted to accommodate

As best seen in FIG. 1, a heating element 88 (preferably an electric resistant heating band, an induction heater or combination thereof as stated supra) is provided against the outside surface of the barrel 30 for heating and melting the pellets 16 being conveyed through the melt section 36. The start of the heating element 88 is located after a short feed section 57, and then extends the remaining length 34 of the barrel 30 to the extrusion nozzle 80. The feed section 57 shown in FIG. 1 is preferably between about 1 to 1.5 turns of the flight 56 from the mouth 31 of the barrel, and the melt section 36 is preferable about 11 turns from the end of the feed section 57 to the end of the flight length 72. However, the lengths of the feed and melt sections 57, 36, respectively, may be shortened or lengthened according to the physical properties of the plastic pellets, geometry of the screw, and output of the heating element.

As shown in FIGS. 1 and 6, the heating element 88 is wrapped with one or more (preferably two) insulating blankets 90. The heating element 88 is controlled using a temperature controller 84 with a thermocouple 86 (preferably a J-type shim thermocouple) positioned between each blanket 90 and outside surface of the barrel 30. The heating element 88 can be electric resistant, induction or a combination thereof. In operation, melting of the pellets 16 typically occurs in the outer periphery of the channel 59, adjacent the inner surface of the bore 37 of the conically shaped bore 35 of the barrel 30, whereby a thin layer of molten material forms at or immediately near the mouth 31 of the barrel 30. The melting continues as pellets 16 are transferred through the melt section 36, to a homogenous molten state at the extrusion nozzle 80 for printing at the printer head 12.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. To the extent that any meaning or definition of a term in this document conflicts with any meaning or definition of the same term in a document incorporated by reference, the meaning or definition assigned to that term in this document shall govern.

What is claimed is:

1. A single screw micro-extruder for a 3D printer having a printer head with a torque drive mechanism, the micro-extruder comprising:
a feed chamber having a conically shaped feed surface converging downwardly, said feed chamber having an opening for receiving solid plastic pellets;
an extrusion barrel having a length, a longitudinal axis extending downwardly from the feed chamber, and an inner conically shaped, concentric bore between input and output ends with a conical angle, the bore having a mouth at the input end and an exit opening at the output end with a melt section therebetween, and a diameter at the mouth being greater than a diameter of the exit opening;
an extrusion nozzle at the output end of said extrusion barrel; and
a rotatable screw having a length extending along the longitudinal axis through the conical bore of the extrusion barrel, the screw is rotatably supported at a drive-shaft portion by a bearing-seal housing after passing through the feed chamber for attachment to the torque drive mechanism of the printer head, and further includes:
i) a root core with a surface;
ii) a flight located on and projecting radially from the root core, the flight having a lead length forming a channel with a helix angle and a helical path between the root core surface of the screw and an inner surface of the conically shaped, concentric bore of said extrusion barrel, the helical path extending from the input end and into the melt section of said extrusion barrel toward the extrusion nozzle;
iii) an outermost surface of the flight having a land adjacent the inner surface of the conically shaped bore thereby forming a conical angle substantially equal to the conical angle of the barrel from the input end through the melt section of the extrusion barrel, such that the flight works closely with the inner surface of the bore to engage and wedgingly urge pellets from said input end downwardly through said extrusion barrel to the extrusion nozzle; and
iv) a constant or tapered diameter of the root core of the screw in a direction from the input end toward the output end of the extrusion barrel forms a decreasing channel root depth in the helical path for compression of the plastic pellets between the root core surface and the inner surface of the bore for pressurizing melt in the melt section of said extrusion barrel to exit the extrusion nozzle.

2. The micro-extruder of claim 1, wherein the channel root depth of the channel of the screw at the mouth of the extrusion barrel is about 0.2 to 0.4 inches.

3. The micro-extruder of claim 1, wherein the channel root depth of the channel of the screw at the exit opening of the extrusion barrel is about 0.025 to 0.075 inches.

4. The micro-extruder of claim 1, wherein the diameter at the mouth of the bore of the barrel is at least between 0.75 to 1.5 inches and the diameter of the exit opening is at least between 0.25 to 0.75 inches.

5. The micro-extruder of claim 1, wherein the feed chamber is made of a thermal insulating material.

6. The micro-extruder of claim 1, wherein a thermal resistant insert is used as a thermal barrier between the feed chamber and the input end of the extrusion barrel.

7. The micro-extruder of claim 6, wherein the feed chamber is made of a thermally conductive material.

8. The micro-extruder of claim 7, wherein the feed chamber includes heat-transfer fins.

9. The micro-extruder of claim 1, further including a shroud enclosure around the feed chamber for a cooling medium to pass therebetween.

10. The micro-extruder of claim 1, wherein the torque drive mechanism and rotatable screw are coupled using a pulley and belt system.

11. A single screw micro-extruder for a 3D printer having a printer head with a torque drive mechanism, the micro-extruder comprising:
a feed chamber having a conically shaped feed surface converging downwardly, said feed chamber having an opening for receiving solid plastic pellets;
an extrusion barrel having a length, a longitudinal axis extending downwardly from the feed chamber, and an inner conically shaped, concentric bore between input and output ends with a conical angle, the bore having a mouth at the input end and an exit opening at the output end with a melt section therebetween, and a diameter at the mouth being greater than a diameter of the exit opening;
an extrusion nozzle at the output end of said extrusion barrel; and
a rotatable screw having a length extending from the torque drive mechanism of the printer head and along the longitudinal axis through the conical bore of the extrusion barrel, the screw is rotatably supported by a bearing-seal housing and passes through the feed chamber, and further includes:
i) a root core with a surface;
ii) a flight located on and projecting radially from the root core, the flight having a lead length forming a channel with a helix angle and a helical path between the root core surface of the screw and an inner surface of the conically shaped, concentric bore of said extrusion barrel, the helical path extending from the input end and into the melt section of said extrusion barrel toward the extrusion nozzle;
iii) an outermost surface of the flight having a land adjacent the inner surface of the conically shaped bore thereby forming a conical angle substantially equal to the conical angle of the barrel from the input end through the melt section of the extrusion barrel, such that the flight works closely with the inner surface of the bore to engage and wedgingly urge pellets from said input end downwardly through said extrusion barrel to the extrusion nozzle;
iv) a constant or tapered diameter of the root core of the screw in a direction from the input end toward the output end of the extrusion barrel forms a decreasing channel root depth in the helical path for compression of the plastic pellets between the root core surface and the inner surface of the bore for pressurizing melt in the melt section of said extrusion barrel to exit the extrusion nozzle; and
v) an auger section in the feed chamber to push plastic pellets toward the input end of the barrel.

12. The micro-extruder of claim 11, further including a screw extension adjustment for positioning the screw for clearance between the land of the flight and the inner surface of the conically shaped bore of said extrusion barrel.

13. The micro-extruder of claim 11, wherein the conically shaped feed surface of the feed chamber includes grooves or pitting.

14. The micro-extruder of claim 11, further including a shroud enclosure around the feed chamber with an inlet opening and an outlet opening for a cooling medium to pass therebetween.

15. The micro-extruder of claim 11, wherein the torque drive mechanism and rotatable screw are coupled using a pulley and belt system.

16. A single screw micro-extruder for a 3D printer having a printer head with a torque drive mechanism, the micro-extruder comprising:
a feed chamber having a conically shaped feed surface converging downwardly, said feed chamber having an opening for receiving solid plastic pellets;
an extrusion barrel having a length not greater than 12 inches, a longitudinal axis extending downwardly from the feed chamber, and an inner conically shaped, concentric bore between input and output ends with a conical angle, the bore having a mouth at the input end and an exit opening at the output end with a melt section therebetween, and a diameter at the mouth being greater than a diameter of the exit opening and not greater than 2 inches;
an extrusion nozzle at the output end of said extrusion barrel; and
a rotatable screw having a length extending from the torque drive mechanism of the printer head and along the longitudinal axis through the conical bore of the extrusion barrel, the screw is rotatably supported by a bearing-seal housing and passes through the feed chamber, and further includes:
i) a root core with a surface;
ii) a flight located on and projecting radially from the root core, the flight having a lead length forming a channel with a helix angle and a helical path between the root core surface of the screw and an inner surface of the conically shaped, concentric bore of said extrusion barrel, the helical path extending from the input end and into the melt section of said extrusion barrel toward the extrusion nozzle;
iii) an outermost surface of the flight having a land adjacent the inner surface of the conically shaped bore thereby forming a conical angle substantially equal to the conical angle of the barrel from the input end through the melt section of the extrusion barrel, such that the flight works closely with the inner surface of the bore to engage and wedgingly urge pellets from said input end downwardly through said extrusion barrel to the extrusion nozzle;
iv) a constant or tapered diameter of the root core of the screw in a direction from the input end toward the output end of the extrusion barrel forms a decreasing channel root depth in the helical path for compression of the plastic pellets between the root core surface and the inner surface of the bore for pressurizing melt in the melt section of said extrusion barrel to exit the extrusion nozzle; and
v) an auger portion in the feed chamber to keep plastic pellets moving toward the input end of the barrel.

17. The micro-extruder of claim 16, wherein the torque drive mechanism is mounted lateral and parallel to the longitudinal axis of the extrusion barrel and the diameter of the exit opening is at least between 0.25 to 0.75 inches.

18. The micro-extruder of claim 16, wherein the torque drive mechanism is mounted lateral and perpendicular to the longitudinal axis of the extrusion barrel and the diameter of the exit opening is at least between 0.25 to 0.75 inches.
